(19) United States
(12) Patent Application Publication
(10) Pub. No.: US 2006/0059737 A1
(43) Pub. Date: Mar. 23, 2006

(54) Object for ornamental purposes

(75) Inventor: Andrea Lanti, Vicenza (IT)

Correspondence Address: BUCKNAM AND ARCHER, 1077 NORTHERN BOULEVARD, ROSLYN, NY, 11576, US

(73) Assignee: NOVA RANK EXPORT S.R.L.

(21) Appl. No.: 11/071,625

(22) Filed: Mar. 3, 2005

(30) Foreign Application Priority Data
Jun. 15, 2004 (IT) VI2004A000147

(51) Int. Cl. G09F 3/00

(52) U.S. Cl. 40/316

(57) ABSTRACT

There is described an object for ornamental purposes of the type that has at least one channel 1 where at least one decorative element 2 is arranged that engages, with its side appendices, at tracks 3 formed on the side edges of the channel, which allows the sliding of the decorative element along the channel itself. The object for ornamental purposes includes elements that allow the user to remove the sliding element(s) from the channel(s) in which it or they are arranged so as to allow the replacement of the element(s) with other sliding element(s) into the channel(s), in order to modify the overall aesthetic appearance of the object.

### BACKGROUND OF THE INVENTION

The present invention relates to an object for ornamental purposes or, more particularly, to an article of jewelry.

For some time objects for ornamental purposes have been known that have one or more channels where one or more decorative elements are arranged that engage, with two of their side appendices, at tracks or slits formed on the side edges of the channel. This permits the sliding of the element or elements along the channel, which allows the modification of the overall configuration of the object for ornamental purposes. An example of such an object for ornamental purposes is described in U.S. Pat. No. 5,896,757, to Kharloubian, granted Apr. 27, 1999.

However, in these prior art embodiments the decorative elements are inserted in the channel at the manufacturing stage of the object and it is impossible for the user to withdraw them from the channel, or to insert others in the same channel.

### SUMMARY OF THE INVENTION

The object of the present invention is to provide an object for ornamental purposes of the type described which allows the user to modify the overall aesthetic appearance of the object for ornamental purposes.

This object is accomplished, according to the present invention, by providing means that allow the user to take out the sliding elements from the channels in which they are arranged, in order to allow the replacement of said elements with other sliding elements, or the integration of additional sliding elements inside the channels in question.

### BRIEF DESCRIPTION OF THE DRAWINGS

The invention will now be described in detail, with reference to some embodiments thereof, given as non-limiting examples with the help of the accompanying drawings, in which:

FIG. 1 is a front view of a first embodiment of the object for ornamental purposes according to the present invention;

FIG. 2 is a rear view of the object for ornamental purposes shown in FIG. 1;

FIG. 3 is a longitudinal cross-sectional view of the object shown in FIG. 1 taken along line III-III of FIG. 1;

FIGS. 4 and 5 are two axonometric views of the object for ornamental purposes according to the invention, shown at the opposite faces thereof; and

FIGS. 6 to 14 show several different embodiments of the object for ornamental purposes according to the present invention.

### DETAILED DESCRIPTION OF THE INVENTION

In FIGS. 1 to 5 it can be seen that the object for ornamental purposes according to the invention has a channel 1, where two decorative elements 2 can slide, which engage, with their side appendices 2′, at slits or tracks 3 (see FIG. 5) formed on the side edges of the channel. With such a constructive arrangement the decorative elements 2 can slide along the channel, during normal use of the object for ornamental purposes.

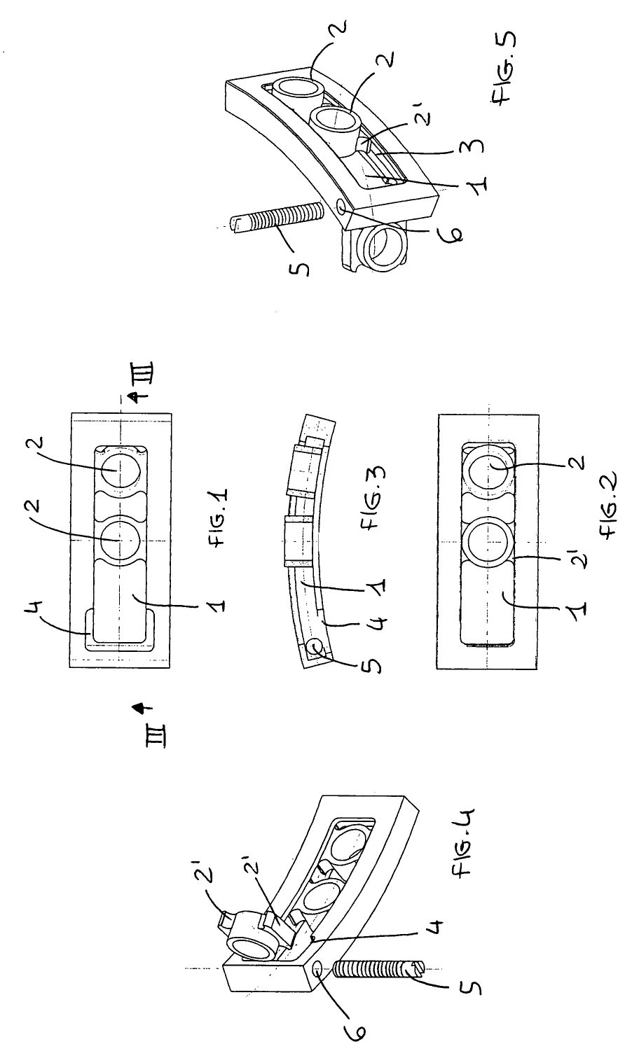

A fundamental characteristic of the device according to the invention consists of the fact that, as can be seen in FIGS. 1, 3 and 4, the channel 1 has a widening 4, on one of the side faces of the object, at one end of the channel. The presence of this widening ensures that the decorative elements 2 can be removed from the channel or inserted back in again, all as can clearly be seen in FIGS. 4 and 5.

In order to allow the insertion of the decorative elements 2 inside the channel 1, a pin 5 is arranged transversally in the channel, the presence of which inside the channel blocks it and therefore prevents the various decorative elements from being removed from the channel or prevents the insertion of other decorative elements into it. This pin, which advantageously is threaded, can be inserted into or withdrawn from its seat 6 directly by the user, who can thus decide for himself what and how many elements to insert inside the channel, according to his particular tastes regarding the aesthetic characterization of the device according to the invention.

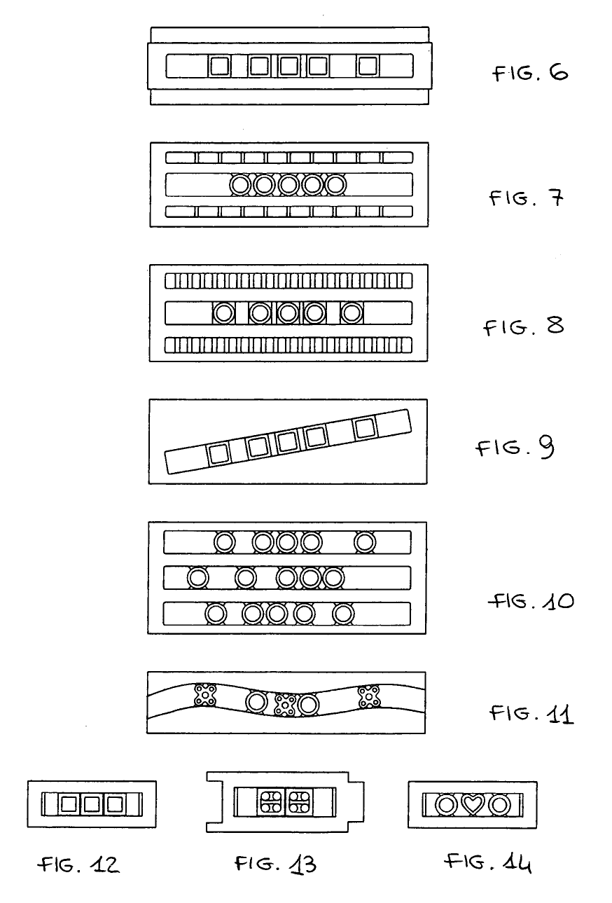

As can be seen in FIGS. 6 to 14, the object for ornamental purposes according to the present invention can have one or more channels, the channels can be arranged with an inclined direction with respect to the longitudinal direction of the object, and finally the channels can also have a curvilinear progression as illustrated in FIG. 11. Moreover, different shaped elements can be arranged in the same channel.

As a non-limiting example, the object for ornamental purposes can be used to make bracelets, necklaces, earrings, brooches and jewelry in general, watches, watch-holders and relative cases.

The embodiments illustrated and described herein are given only as non-limiting examples. In particular, the channels can take up very different geometric arrangements to those mentioned above, limited only by one's inspiration and creativity. For example, said channels can be in the shape of a cross, circular, heart-shaped, as well as take the form of letters of the alphabet and numbers.

From the above it can thus be seen that through the device according to the present invention, the user certainly has the possibility of easily and simply modifying the configuration of the object for ornamental purposes, this being obtained thanks to the modification of the number and quality of the sliding elements arranged in the channels present in the object itself.

What is claimed is:

1. An object for ornamental purposes of the type that has at least one channel (1) where at least one decorative element (2) is arranged that engages with its side appendices (2′), at tracks (3) formed on side edges of said channel (1), which allows the sliding of said elements (2) along the channel itself, and means that allow the user to remove a sliding element from the channel in which it is arranged to allow the insertion or withdrawal of said element into or from said channel, in order to modify the overall aesthetic appearance of the object for ornamental purposes.

2. The object for ornamental purposes according to claim 1, wherein at one of its ends a widening (4) is formed in said at least one channel (1) on one of its faces, which allows the removal of the decorative element (2) from the channel itself, a removable pin (5) is arranged in the channel at said widening, said pin being arranged transversally in the channel to prevent the decorative element from coming out, whereby said pin is withdrawn from the channel when the user wishes to remove the decorative element from the channel.

3. The object for ornamental purposes according to claim 2, wherein the pin (5) is externally threaded and inserts into a seat (6) that is also threaded.

4. The object for ornamental purposes according to claim 1, wherein the object has a plurality of channels (1), in each of which one or more elements (2) for ornamental purposes are arranged.
